(19) United States
(12) Patent Application Publication
(10) Pub. No.: US 2016/0092565 A1
(43) Pub. Date: Mar. 31, 2016

(54) Unified Search on a Personal Computing Device

(71) Applicant: Microsoft Corporation, Redmond, WA (US)

(72) Inventors: Sean Mckenna, Seattle (CA); Akhilesh Kaza, Sammamish, WA (US); Andrew J. Clinick, Issaquah, WA (US); Sami Khoury, Kirkland, WA (US)

(73) Assignee: Microsoft Corporation

(21) Appl. No.: 14/498,863

(22) Filed: Sep. 26, 2014

(51) Int. Cl. G06F 17/30

(52) U.S. Cl. CPC G06F 17/30864; G06F 17/30554

(57) ABSTRACT

A unified search leverages exposed search functions of one or more applications to supplement search results of a global search function. When a user initiates a global search, a local data store is searched to generate a first set of search results. The global search function calls exposed search functions associated with one or more applications, which provide additional search results.

### BACKGROUND

As personal computing devices have become more prevalent, the data available to users through those devices has also increased. However, while a vast amount of data is available to a user of a personal computing device, locating specific data of interest is often difficult.

### SUMMARY

A unified search is described. A global search functionality is provided to enable a user to search against local data on a personal computing device. The global search functionality provides a first set of search results and also calls one or more exposed search functions associated with other application programs. Each exposed search function that is called may provide additional search results.

### BRIEF DESCRIPTION OF THE DRAWINGS

The same numbers are used throughout the drawings to reference like features and components.

FIG. 1 is a pictorial diagram of a user interface displaying results of a unified search.

FIG. 2 is a pictorial diagram of an example computing environment in which a unified search may be implemented.

FIG. 3 is a block diagram of an example data flow of a unified search.

FIG. 4 is a block diagram of select components of a computing device configured to perform a unified search.

FIG. 5 is a flow diagram of an example method for performing a unified search.

### DETAILED DESCRIPTION

The following discussion is directed to a unified search performed through a personal computing device. Personal computing devices may include, but are not limited to, mobile phones, tablet computers, laptop computers, personal digital assistants, desktop computers, and so on. A personal computing device typically includes an operating system and one or more application programs that may be executed on the personal computing device. Various application programs may have associated data against which a user may wish to perform a search. For example, a mobile phone may include applications for managing contact information and calendar information, as well as other applications for accessing music, videos, games, social media, etc.

In an example implementation, one or more applications may enable access to some or all of the data the application manages through, for example, a local data store. The operating system of the personal computing device includes a search functionality, referred to herein as a global search functionality, that enables a user to enter a keyword or other type of search criteria and to initiate a search against the local data store. Furthermore, one or more applications stored on the personal computing device, or accessible via the personal computing device, may also include search functions. One or more applications may expose a search function such that the application search function may be called from outside of the application.

In an example implementation, when a user initiates a global search through the operating system's global search functionality, multiple operations are performed. The operating system searches the local data store, returning any results. In addition, the operating system calls any exposed search functions associated with applications stored on, or accessible to, the personal computing device using the keywords or other search criteria that were entered by the user. Each exposed search function that is called executes, and returns to the operating system results of the search. In this way, search functionality associated with any number of applications is leveraged to provide more user-relevant results when a user performs a global search.

For example, a user may recall having seen a particular video, but can't remember whether they saw it through a post on a social media site, in an email attachment, or on a web-based video channel. Rather than having to go to each possible application and perform a search in an effort to find the video, the user can enter keywords for a search at the operating system level, and the operating system will leverage exposed search functions associated with a social media application, an email application, and a web-based video channel application, returning a more complete set of available search results.

When compared to a user launching multiple applications and performing individual searches through each application, the unified search provides comprehensive search results in less time and using less computing resources. For example, multiple application search functions may be executed without the individual applications having to be executed.

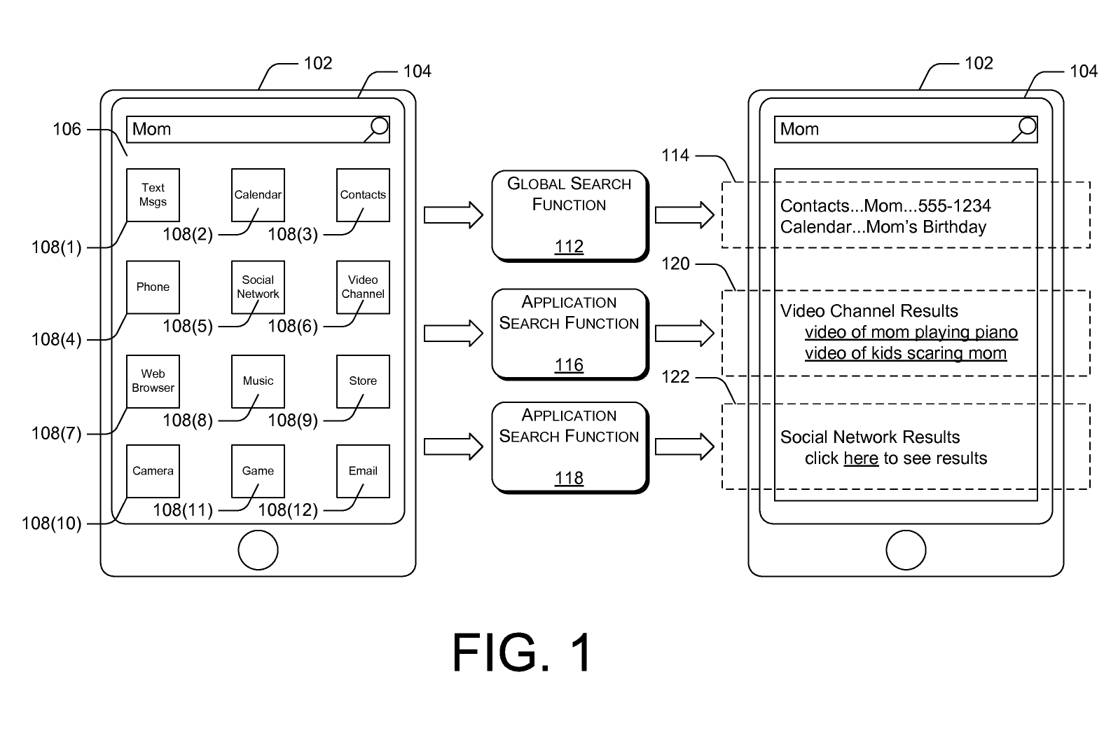

FIG. 1 illustrates an example implementation of a unified search as described herein. Personal computing device 102 includes a display screen 104. When no application is currently active, the operating system displays a user interface 106, which may include, for example, one or more tiles 108, each representing a different application. In an example implementation, user interface 106 also includes a text box 110 for submitting keywords to a global search function 112.

In the illustrated example, a user has entered the keyword “Mom.” In response to receiving the user-submitted keyword, global search function 112 performs a search against any local data stores, and returns global search results 114. In the illustrated example, the global search results 114 include data associated with a contact named “Mom” and data associated with a calendar item labeled “Mom's Birthday.”

In addition to performing a search against a local data store, global search function 112 identifies and invokes one or more application-specific search functions that are exposed for access from outside their respective applications. In the illustrated example, application search function 116 is associated with, and exposed by, a video channel application 108(6) and application search function 118 is associated with, and exposed by, a social network application 108(5).

In response to being invoked by the global search function 112, application search function 116 executes as if invoked from within the video channel application 108(6). Results of the search are returned to the global search function, and the search results 120 are presented for the user. Similarly, in response to being invoked by the global search function 112, application search function 118 executes as if invoked from within the social network application 108(5). In the illustrated example, rather than returning the search results to the global search function 112, application search function 118 returns a link 122, which can be displayed for selection by a user to access the detailed search results.

Search functions associated with applications may be implemented in various ways. For example, as illustrated in FIG. 1, one application may return results when a search function is called, while another application may merely return a link, which must then be selected in order to access the search results. In addition to differences in how results may be presented, application search functions may also differ in any number of other ways. For example, one application may be implemented to search only against data specific to the application, while another application may be implemented to search against one or more web-based data sources. Another application may be implemented such that a search functionality associated with the application merely calls a search functionality of another application, such as a web browser. When a user performs a global search function, application search functions that are called are not controlled by the global search function. Rather, the exposed search functions are executed based on how the search functions are implemented within the applications.

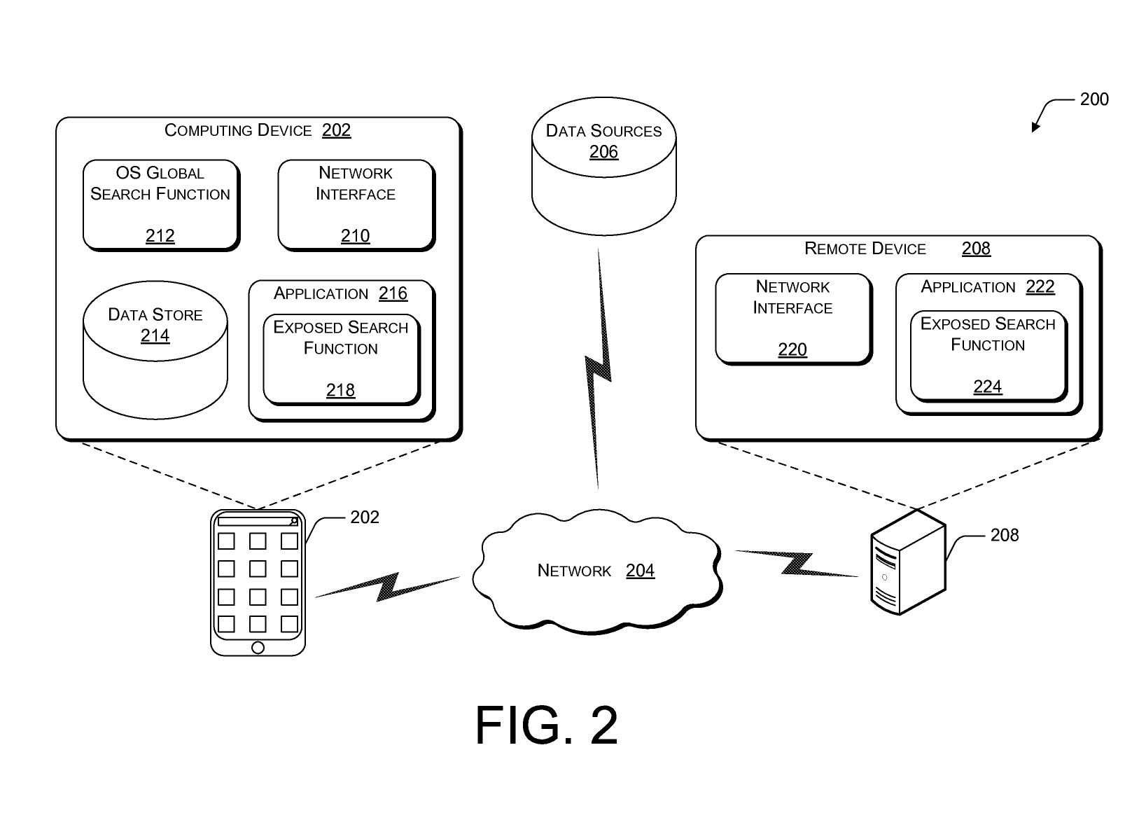

FIG. 2 illustrates an example environment in which a unified search may be implemented. Example environment 200 includes a personal computing device 202, a network 204, one or more remote data sources 206, and one or more remote computing devices 208. Example computing device 202 includes a network interface 210 to enable communication over network 204. Example computing device 202 also includes an operating system (OS) global search function 212, a data store 214, and an application 216 having an exposed search function 218.

Remote device 208 includes a network interface 220 to enable communication over network 204, and an application 222 having an exposed search function 224.

Any number of applications, such as application 216, may store application-specific data in data store 214. For example, applications that typically provide access to web-based information (e.g., a social networking application) may choose to use data store 214 to cache data that a user has accessed through the application. Any data stored in data store 214 is then available to the OS global search function 212. Data store 214 maintains data local to the personal computing device. Particularly for web-based applications, any data stored in data store 214 is limited in comparison to data available through an application-specific search function.

When a user initiates the OS global search function 212, computing device 202 performs a search against data store 214. In addition, the OS global search function 212 calls exposed search function 218 associated with the application 216. Exposed search function 218 may search against data stored on the computing device or data stored in data sources 206.

In addition to calling the exposed search function 218 associated with application 216, the OS global search function 212 may also call any other exposed search functions that are available. For example, through communication over the network 204, OS global search function 212 may call exposed search function 224 on remote device 208.

Search results may include, for example, results from the OS global search against the data store 214, results from exposed search function 218, and results from exposed search function 224.

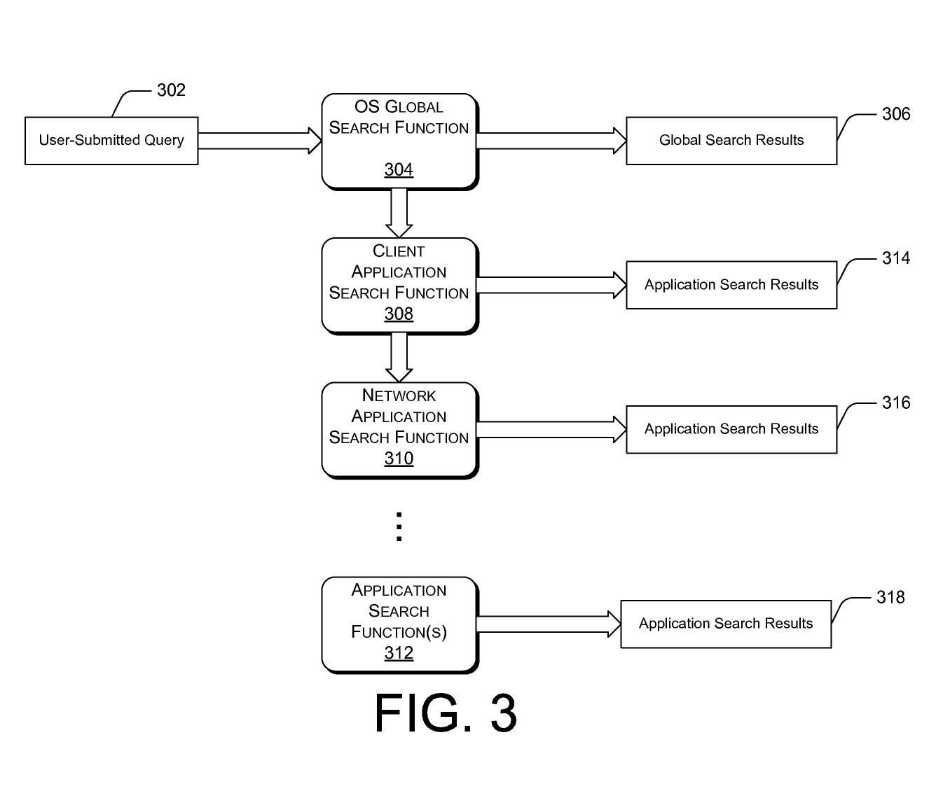

FIG. 3 illustrates an example data flow of a unified search as described herein. Block 302 represents a user query submitted to an operating system (OS) global search function 304. In response to receiving the user query 302, OS global search function 304 performs a search, for example, against a local data store, and returns global search results 306.

Also in response to receiving the user query 302, OS global search function 304 calls any number of available exposed search functions. For example, OS global search function 304 may call a client application search function 308 associated with an application that is available locally. OS global search function 304 may also call a network application search function 310 that is associated with an application available over a network. OS global search function 304 may also call any number of other application search function(s) 312, which may be available locally or remotely.

In response to having been called by OS global search function 304, client application search function 308 returns application search results 314, network application search function 306 returns application search results 316, and application search function(s) 312 return application search results 318.

As described above with reference to FIG. 1, one or more of client application search function 308, network application search function 310, or application search function(s) 312 may return instructions for accessing the search results, rather than directly returning the search results. For example, an application search function 312 may return a link that, when selected, launches the application, rather than returning a full set of search results. The search functionality performed by an application search function that is called by the OS global search function is dependent upon how the particular application search function is designed and implemented within the application with which the search function is associated.

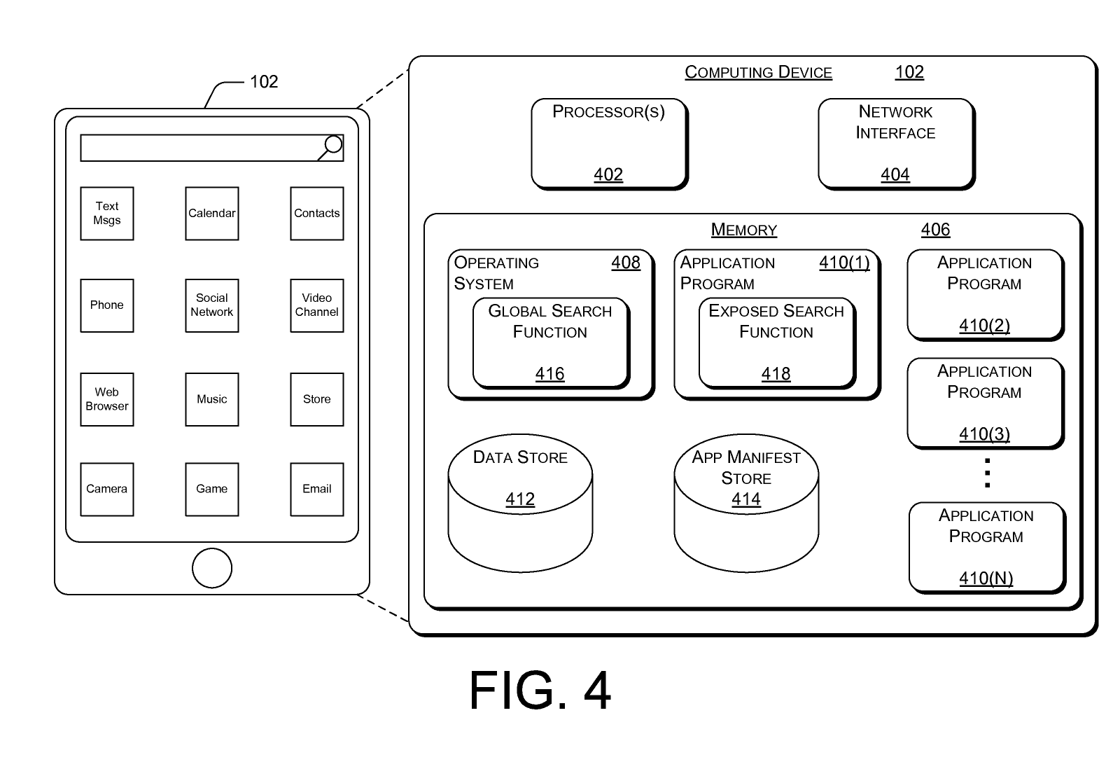

FIG. 4 illustrates select components of an example computing device 102 configured to implement a unified search as described herein. Computing device 102 may include one or more processors 402, a network interface 404, and a memory 406. An operating system 408 and one or more application programs 410 may be stored in memory 406 and executed, at least in part, on the processor(s) 402. Memory 406 also includes a data store 412 and an application manifest store 414. Operating system 408 includes a global search function 416, and one or more application programs 410 may include an exposed search function. For example, application program 410(1) includes exposed search function 418.

Data store 412 may store any type of data that is local to computing device 102. This may include, for example, contact information, text messages, calendar appointments, downloaded email messages, and so on. As described above with reference to FIG. 2, any number of application programs may utilize data store 214 to cache application-specific data. Application manifest store 414 stores application manifests associated with application programs 410. In an example implementation, for a particular application program 410, a corresponding application manifest indicates any exposed functions associated with the application program. For example, an application manifest associated with application program 410(1) would indicate that search function 418 is an exposed search function.

Alternatively, or in addition, the functionality of the unified search function described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any of the components illustrated in FIG. 4 may be implemented using any form of computer-readable media that is accessible by computing device 102 either locally or remotely, including over a network. Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

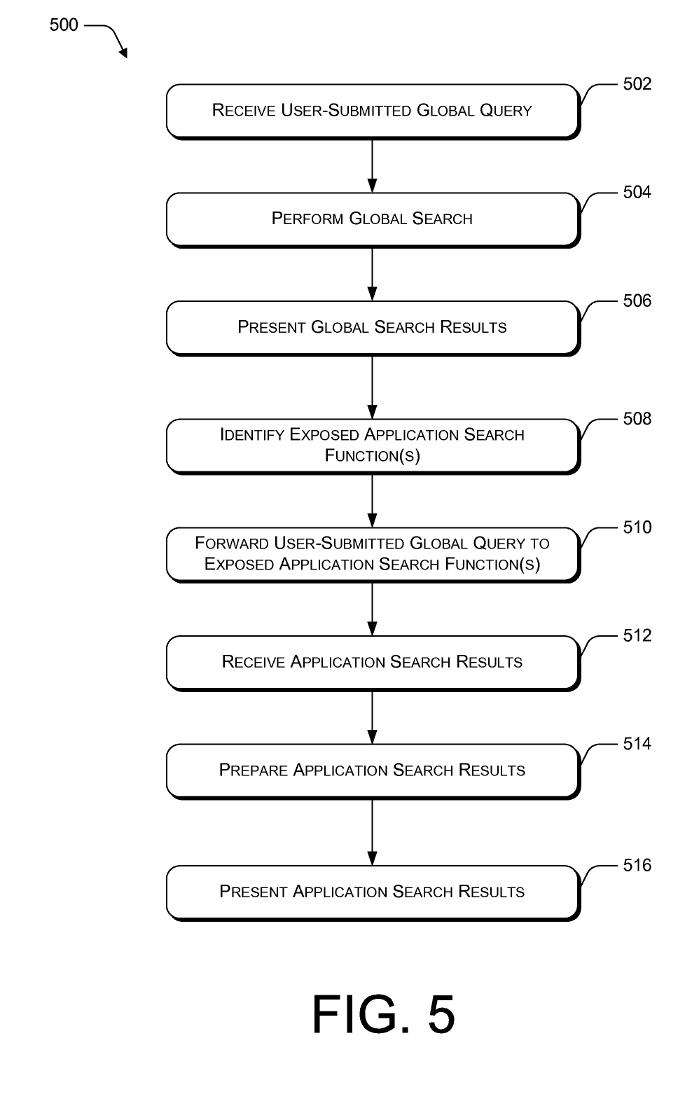

FIG. 5 illustrates an example process 500 for performing a unified search. The process is illustrated as a set of operations shown as discrete blocks. The process may be implemented in any suitable hardware, software, firmware, or combination thereof. The order in which the operations are described is not to be construed as a limitation.

At block 502, operating system 408 receives a user-submitted global query. For example, a user may enter a keyword through a text box associated with a global search function 416 of the operating system 408.

At block 504, the operating system 408 performs a global search. For example, operating system 408 executes the global search function 416. In an example implementation, the global search function 416 uses the user-submitted keyword to search against the local data store 412.

At block 506, the operating system 408 presents the global search results. For example, the operating system 408 may display any results of the search against the local data store 412 in a user interface.

At block 508, operating system 408 identifies exposed application search function(s). For example, operating system 408 may query application manifest store 402 to identify any exposed search functions. Operating system 408 may identify exposed search functions that are local to the computing device 102 and/or that are available to the computing device 102 via a network.

At block 510, operating system 408 calls the identified exposed application search functions with the user-submitted query. For example, operating system 408 may call exposed search function 418 associated with application program 410(1). The operating system 408 may also call other exposed search functions, either local or remote. The global search described with reference to block 504 and the calls to the application search functions described with reference to block 510 may occur in any order or simultaneously.

At block 512, operating system 408 receives results from the exposed search functions that were called. For example, operating system 408 may receive search results from exposed search function 418.

At block 514, operating system 408 prepares the application search results. For example, operating system 408 may organize, sort, format, or otherwise prepare the received search results. In an example implementation, search results are visually partitioned according to the application from which the results are received. Furthermore, in an example implementation, an application may provide, as part of a response to an exposed search function call, some instruction regarding how to present the search results.

At block 516, the operating system 408 presents the application search results. For example, the operating system 408 may display the received search results along with search results from the global search, visually partitioned according to which search returned which results.

Example Clauses

A: A method comprising: receiving user-submitted search criteria; and in response to receiving the user-submitted search criteria: performing a search to obtain a first set of search results; identifying an exposed search function associated with an application program; calling the exposed search function associated with the application program; receiving a response from the exposed search function; and presenting the first set of search results and the response from the exposed search function.

B: The method as Paragraph A recites, wherein performing a search to obtain a first set of search results comprises searching against a local data store.

C: The method as Paragraph A or B recites, wherein the application program comprises a local application program.

D: The method as Paragraph A or B recites, wherein the application program is a remote application program accessible via a network.

E: The method as any of Paragraphs A-D recites, wherein the response from the exposed search function comprises a second set of search results.

F: The method as any of Paragraphs A-E recites, wherein the response from the exposed search function comprises a selectable link to access search results.

G: A personal computing device configured to perform the method as any of Paragraphs A-F recites.

H: A personal computing device comprising: a processor; a memory, communicatively coupled to the processor; and an operating system stored in the memory and executed, at least in part, on the processor, the operating system comprising a global search function, the global search function configured to: receive a user-submitted query; perform a search against a local data store; and call an exposed search function associated with an application program.

I: The personal computing device as Paragraph H recites, further comprising an application program stored in the memory and executed, at least in part, on the processor, the application program comprising the exposed search function.

J: The personal computing device as Paragraph H recites, wherein the exposed search function is associated with an application that is remote to the system.

K: The personal computing device as any of Paragraphs H-J recite, wherein the global search function is further configured to receive a response from the exposed search function.

L: The personal computing device as Paragraph K recites, wherein the response from the exposed search function comprises a set of search results.

M: The personal computing device as Paragraph K recites, wherein the response from the exposed search function comprises a selectable link to access a set of search results.

N: The personal computing device as any of Paragraphs H-M recite, wherein the global search function is further configured to present search results from the search against the local data store and a response from the exposed search function as results of the user-submitted query.

O: The personal computing device as any of Paragraphs H-N recite, implemented as a mobile phone.

P: One or more computer-readable media comprising computer-executable instructions that, when executed, direct a computing system to: receive input that indicates a user interest; query a local data store for local data related to the user interest; present the local data as a first result set; use the input that indicates the user interest to call a search functionality of an application; receive, from the application, a query response; and present the query response as a second result set.

Q: The one or more computer-readable media as Paragraph P recites, wherein the application is accessible via a network connection.

R: The one or more computer-readable media as Paragraph P or Q recites, wherein the query response comprises a selectable link to access a set of search results.

S: The one or more computer-readable media as any of Paragraphs P-R recite, wherein the local data store comprises data cached by one or more application programs

T: A personal computing device comprising the one or more computer-readable media as any of Paragraphs P-S recite.

### CONCLUSION

Although unified search has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

The operations of the example process are illustrated in individual blocks and summarized with reference to those blocks. The process is illustrated as a logical flow of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described process can be performed by resources associated with one or more device(s) 104 such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

We claim:

1. A method comprising:
receiving user-submitted search criteria; and
in response to receiving the user-submitted search criteria:
performing a search to obtain a first set of search results;
identifying an exposed search function associated with an application program;
calling the exposed search function associated with the application program;
receiving a response from the exposed search function; and
presenting the first set of search results and the response from the exposed search function.

2. The method as recited in claim 1, wherein performing a search to obtain a first set of search results comprises searching against a local data store.

3. The method as recited in claim 1, wherein the application program comprises a local application program.

4. The method as recited in claim 1, wherein the application program is a remote application program accessible via a network.

5. The method as recited in claim 1, wherein the response from the exposed search function comprises a second set of search results.

6. The method as recited in claim 1, wherein the response from the exposed search function comprises a selectable link to access search results.

7. A personal computing device configured to perform the method as recited in claim 1.

8. A personal computing device comprising:
a processor;
a memory, communicatively coupled to the processor;
an operating system stored in the memory and executed, at least in part, on the processor, the operating system comprising a global search function, the global search function configured to:
receive a user-submitted query;
perform a search against a local data store; and
call an exposed search function associated with an application program.

9. The personal computing device as recited in claim 8, further comprising an application program stored in the memory and executed, at least in part, on the processor, the application program comprising the exposed search function.

10. The personal computing device as recited in claim 8, wherein the exposed search function is associated with an application that is remote to the system.

11. The personal computing device as recited in claim 8, wherein the global search function is further configured to receive a response from the exposed search function.

12. The personal computing device as recited in claim 11, wherein the response from the exposed search function comprises a set of search results.

13. The personal computing device as recited in claim 11, wherein the response from the exposed search function comprises a selectable link to access a set of search results.

14. The personal computing device as recited in claim 8, wherein the global search function is further configured to present search results from the search against the local data store and a response from the exposed search function as results of the user-submitted query.

15. The personal computing device as recited in claim 8, implemented as a mobile phone.

16. One or more computer-readable media comprising computer-executable instructions that, when executed, direct a computing system to:
receive input that indicates a user interest;
query a local data store for local data related to the user interest;
present the local data as a first result set;
use the input that indicates the user interest to call a search functionality of an application;
receive, from the application, a query response; and
present the query response as a second result set.

17. The one or more computer-readable media as recited in claim 16, wherein the application is accessible via a network connection.

18. The one or more computer-readable media as recited in claim 16, wherein the query response comprises a selectable link to access a set of search results.

19. The one or more computer-readable media as recited in claim 16, wherein the local data store comprises data cached by one or more application programs.

20. A personal computing device comprising the one or more computer-readable media as recited in claim 16.
